(19) United States
(12) Patent Application Publication
(10) Pub. No.: US 2011/0064486 A1
(43) Pub. Date: Mar. 17, 2011

(54) DEVELOPING DEVICE AND IMAGE FORMING APPARATUS

(76) Inventor: Satoru FURUYA, Tokyo (JP)

(21) Appl. No.: 12/858,704

(22) Filed: Aug. 18, 2010

(30) Foreign Application Priority Data
Sep. 11, 2009 (JP) 2009-210602

(51) Int. Cl. G03G 15/08

(52) U.S. Cl. 399/281; 399/286

(57) ABSTRACT

A developing device includes a developer supporting member for attaching developer to a static latent image supporting member supporting a static latent image; and a developer supplying member for supplying developer to the developer supporting member. The developer supporting member has a surface with a static friction coefficient in a range of 0.41 and 1.81. The developer supplying member is pushed against the developer supporting member for a pushing amount in a range of 0.5 mm and 1.5 mm.

### BACKGROUND OF THE INVENTION AND RELATED ART STATEMENT

The present invention relates to an image forming apparatus of an electro-photography type and a developing device disposed in the image forming apparatus.

In a conventional image forming apparatus of an electro-photography type, a surface of a photosensitive member is exposed to form a static latent image. After the static latent image is developed to form a developer image, the developer image is transferred to a sheet (a medium). A developing device is provided for developing the static latent image, and includes a developing roller for supporting toner (developer) and attaching toner to the photosensitive member.

In the conventional image forming apparatus, when the developing roller has a surface with a low sliding property, it is difficult to properly scrape off toner not transferred and remaining on the surface of the developing roller (referred to as remaining toner), thereby causing ghost. When ghost occurs, a previous image is printed one more time like an afterimage. In some occasions, fog occurs, in which toner is transferred to a white area where an image is not supposed to be formed.

In order to improve the sliding property of the surface of the developing roller, there has been proposed a technology, in which the surface of the developing roller formed of a urethane rubber as a base member is modified through immersion in an isocyanate solution (refer to Patent Reference).

Patent Reference: Japanese Patent Publication No. 2000-089557

According to Patent Reference, the conventional developing roller has a static friction coefficient at a relatively high level of 4.72. Accordingly, in order to properly scrape off remaining toner on the surface of the developing roller, it is necessary to push the developing roller against a supply roller for a large pushing amount or with a large pushing force. As a result, when the conventional image forming apparatus performs a printing operation at a high speed, a torque tends to increase due to a large frictional force between the developing roller and the supply roller, thereby increasing a load applied to a motor and a gear of a developing device.

In view of the problems described above, an object of the present invention is to provide a developing device and an image forming apparatus capable of solving the problems of the conventional developing device. In the present invention, it is possible to prevent ghost without increasing a load applied to a motor or other component of the developing device.

Further objects and advantages of the invention will be apparent from the following description of the invention.

### SUMMARY OF THE INVENTION

In order to attain the objects described above, according to the present invention, a developing device includes a developer supporting member for attaching developer to a static latent image supporting member supporting a static latent image; and a developer supplying member for supplying developer to the developer supporting member. The developer supporting member has a surface with a static friction coefficient in a range of 0.41 and 1.81. The developer supplying member is pushed against the developer supporting member for a pushing amount in a range of 0.5 mm and 1.5 mm.

In the present invention, as described above, the developer supporting member has the surface with the static friction coefficient in the range of 0.41 and 1.81, and the developer supplying member is pushed against the developer supporting member for the pushing amount in the range of 0.5 mm and 1.5 mm. Accordingly, it is possible to prevent ghost without increasing a load applied to a motor or a gear of the developing device.

### BRIEF DESCRIPTION OF THE DRAWINGS

FIG. 1 is a schematic sectional view showing a configuration of an image forming apparatus according to a first embodiment of the present invention;

FIG. 2 is a schematic sectional view showing a configuration of a photosensitive drum unit including a developing device of the image forming apparatus according to the first embodiment of the present invention;

FIG. 3 is a schematic perspective view showing a developing roller of the developing device according to the first embodiment of the present invention;

FIG. 4 is a schematic perspective view showing a supplying roller of the developing device according to the first embodiment of the present invention;

FIG. 5 is a schematic perspective view showing a method of measuring a static friction coefficient of the developing roller of the developing device according to the first embodiment of the present invention;

FIG. 6 is a schematic perspective view showing a method of measuring a pushing amount of a supply roller with respect to the developing roller of the developing device according to the first embodiment of the present invention;

FIGS. 7(A) and 7(B) are schematic views for explaining a method of evaluating ghost of the developing device according to the first embodiment of the present invention;

FIGS. 8(A) and 8(B) are schematic views showing a method of measuring an electric resistivity of a foamed member of a supply roller of a developing device before carbon black is fixed to the foamed member according to a second embodiment of the present invention;

FIG. 9 is a schematic view showing the method of measuring an electric resistivity of the supply roller of the developing device according to the second embodiment of the present invention; and

FIGS. 10(A) and 10(B) are schematic views showing a method of measuring a residual strain of the supply roller of the developing device according to the second embodiment of the present invention.

### DETAILED DESCRIPTION OF PREFERRED EMBODIMENTS

Hereunder, embodiments of the present invention will be explained with reference to the accompanying drawings.

### First Embodiment

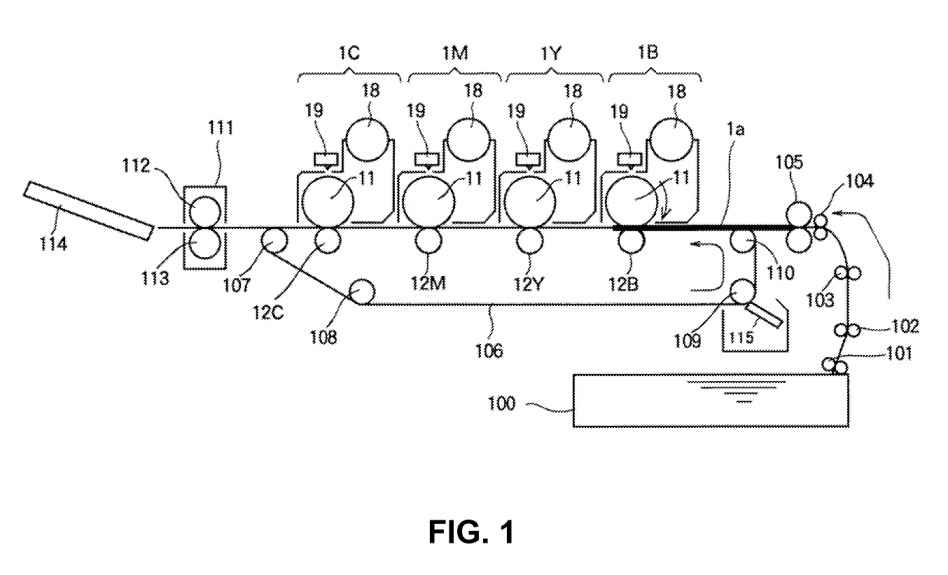

A first embodiment of the present invention will be explained. FIG. 1 is a schematic sectional view showing a configuration of an image forming apparatus according to the first embodiment of the present invention. The image forming apparatus is configured as a color electro-photography printer of a tandem type capable of forming an image in four colors such as black (B), yellow (Y), magenta (M), and cyan (C).

As shown in FIG. 1, the image forming apparatus includes photosensitive drum units 1B, 1M, 1Y, and 1B for forming an image in each of the four colors of black (B), yellow (Y), magenta (M), and cyan (C). The photosensitive drum units 1B, 1M, 1Y, and 1B are arranged in this order along a transportation path of a sheet 1a (a print medium) from an upstream side thereof (a right side in FIG. 1). The photosensitive drum units 1B, 1M, 1Y, and 1B are detachably attached to a main body (not shown) of the image forming apparatus.

In the embodiment, a sheet supply cassette 100 is disposed at a lower portion of the image forming apparatus, in which the sheet 1a is retained in a stacked state. A sheet supply roller 101 is disposed at an end portion of the sheet supply cassette 100 in a picking up direction thereof (the right side in FIG. 1) for separating and picking up the sheet 1a one by one.

In the embodiment, transportation roller pairs 102, 103, and 104 are arranged for transporting the sheet 1a picked up with the sheet supply roller 101 along the transportation path. A register roller pair 105 is disposed in front of the photosensitive drum units 1B, 1M, 1Y, and 1B along the transportation path for supplying the sheet 1a transported with the transportation roller pairs 102, 103, and 104 to the photosensitive drum units 1B, 1M, 1Y, and 1B while correcting a skew of the sheet 1a.

In the embodiment, transfer rollers 12B, 12Y, 12M, and 12C (collectively referred to as transfer rollers 12) are arranged to face the photosensitive drum units 1B, 1M, 1Y, and 1B, respectively. A transportation belt 106 is extended around the transfer rollers 12B, 12Y, 12M, and 12C. In addition to the transfer rollers 12B, 12Y, 12M, and 12C, the transportation belt 106 is extended around a drive roller 107, and tension rollers 108, 109, and 110. The transportation belt 106 is configured to attach the sheet 1a to a surface thereof through an electric static force. When the drive roller 107 rotates, the transportation belt 106 moves and passes through between the photosensitive drum units 1B, 1M, 1Y, and 1B and the transfer rollers 12B, 12Y, 12M, and 12C.

In the embodiment, a belt cleaning blade 115 is arranged under the transportation belt 106 for removing toner adhering to the transportation belt 106. A fixing device 111 is disposed on a downstream side of the photosensitive drum units 1B, 1M, 1Y, and 1B (the left side in FIG. 1). The fixing device 111 includes a fixing roller 112 and a pressing roller 113, so that the fixing device 111 transports the sheet 1a while heating and pressing the sheet 1a. A discharge tray 114 is disposed on a downstream side of the fixing device 11 (the left side in FIG. 1) for holding the sheet 1a discharged from the fixing device 11 after an image is formed on the sheet 1a.

A configuration of the photosensitive drum units 1B, 1M, 1Y, and 1B will be explained next. It is noted that, except a type of toner to be used, the photosensitive drum units 1B, 1M, 1Y, and 1B have an identical configuration. In the following description, the photosensitive drum units 1B, 1M, 1Y, and 1B will be explained collectively as a photosensitive drum unit 1.

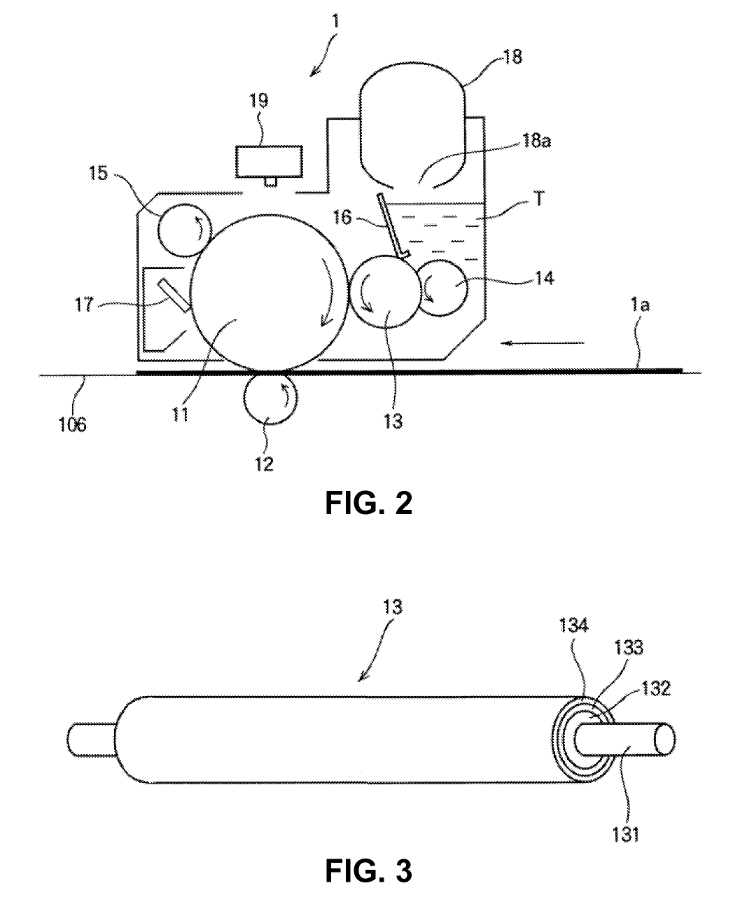

FIG. 2 is a schematic sectional view showing the configuration of the photosensitive drum unit 1 including a developing device of the image forming apparatus according to the first embodiment of the present invention. As shown in FIG. 2, the photosensitive drum unit 1 includes a photosensitive drum 11 as a static latent image supporting member.

In the embodiment, along a rotational direction of the photosensitive drum 11 (a clockwise direction in FIG. 2), there are arranged a charging roller 15 for uniformly charging a surface of the photosensitive drum 11; an exposure device 19 (a static latent image LED light source) for exposing the surface of the photosensitive drum 11 and forming a static latent image thereon; a developing roller 13 as a developer supporting member for attaching toner (developer) to the surface of the photosensitive drum 11; and a cleaning blade 17 for removing remaining toner (non-transferred toner, fog toner, and the like) on the surface of the photosensitive drum 11.

In the embodiment, a regulating blade 16 is disposed to abut against a surface of the developing roller 13 for regulating a thickness of a toner layer on the surface of the developing roller 13. Further, a supplying roller 14 is disposed as a developer supplying member to abut against the surface of the developing roller 13 for supplying toner to the developing roller 13. A toner cartridge 18 is detachably arranged above the developing roller 13. The toner cartridge 18 is provided for supplying toner T (refer to FIG. 2) to the supplying roller 14 and an upper space of the developing roller 13 (a toner hopper) through a toner supply opening 18a.

In the embodiment, the exposure device 19 is disposed outside the photosensitive drum unit 1, and is attached to the main body of the image forming apparatus. In the photosensitive drum unit 1, at least the developing roller 13, the supplying roller 14, the regulating blade 16, and the toner hopper are collectively referred to as the developing device, i.e., a device for developing the static latent image.

In the embodiment, a power source (not shown) is provided for applying a charging voltage to the charging roller 15. The charging roller 15 is arranged to rotate in an arrow direction in FIG. 2 while contacting with the surface of the photosensitive drum 11. Further, a power source (not shown) is provided for applying a voltage to the developing roller 13, so that a potential difference is generated between the developing roller 13 and the photosensitive drum 11. The developing roller 13 is arranged to rotate in an arrow direction in FIG. 2 while contacting with the surface of the photosensitive drum 11. Further, a power source (not shown) is provided for applying a voltage to the supplying roller 14, so that a potential difference is generated between the supplying roller 14 and the developing roller 13. The supplying roller 14 is arranged to rotate in an arrow direction in FIG. 2 while contacting with the surface of the developing roller 13.

In the embodiment, the cleaning blade 17 is arranged to abut against the surface of the photosensitive drum 11, so that the cleaning blade 17 scrapes off remaining toner on the surface of the photosensitive drum 11 into a waste toner retaining space disposed at a lower portion of the photosensitive drum unit 1. After waste toner is scraped off into the waste toner retaining space, a waste toner collecting unit (not shown) transports and collects waste toner.

In the embodiment, a power source (not shown) is provided for applying a voltage to the transfer roller 12, so that a potential difference is generated between the transfer roller 12 and the photosensitive drum 11. The transportation belt 106 is arranged to pass through a nip portion between the photosensitive drum 11 and the transfer roller 12, so that a toner image formed on the surface of the photosensitive drum 11 is transferred to the sheet 1a statically attached to the surface of the transportation belt 106.

In the embodiment, the image forming apparatus is configured such that the photosensitive drum units 1B, 1M, 1Y, and 1B are driven in synchronization with the transportation belt 106 (the drive roller 107), so that the toner images in colors are sequentially transferred and overlapped on the sheet 1a statically attached to the surface of the transportation belt 106. After the toner images are transferred to the sheet 1a, the fixing device 111 heats and presses the sheet 1a, so that the toner images are fixed to the sheet 1a. After the toner images are fixed to the sheet 1a, the sheet 1a is discharged from the fixing device 111 to the discharge tray 114.

A configuration of the developing roller 13 will be explained next. FIG. 3 is a schematic perspective view showing the developing roller 13 of the developing device according to the first embodiment of the present invention.

In the embodiment, the developing roller 13 is formed of a core metal 131 made of stainless steel and an elastic layer 132 disposed on an outer circumferential surface of the core metal 131. Further, an intermediate layer 133 is formed on an outer circumferential surface of the elastic layer 132, and a surface layer 134 is formed on an outer circumferential surface of the intermediate layer 133. The core metal 131 may be coated with an adhesive or a primer to increase an adhesive property between the core metal 131 and the elastic layer 132. In this case, the adhesive or the primer as a coating material may be formed of a conductive material. The core metal 131 has an outer diameter of 10 mm, and the developing roller 13 has an outer diameter of 16 mm.

In the embodiment, the elastic layer 132 of the developing roller 13 may be formed of a material such as an ethylene-propylene-diene rubber (EPDM), a styrene-butadiene rubber (SBR), a silicone rubber, a polyurethane type elastomer, and the like. An additive such as a conductive agent, silicone oil, and the like may be added as necessary. The conductive agent as the additive includes carbon black, graphite, potassium titanate, iron oxide, titanium oxide (TiO₂), zinc oxide (ZnO), tin oxide (SnO₂), and the like.

In the embodiment, the intermediate layer 133 of the developing roller 13 may be formed of a material such as a polyurethane type elastomer, an acrylonitril-butadiene rubber, a hydrogenated acrylonitril-butadiene rubber, a chloroprene rubber (CR), natural rubber, a butadiene rubber (BR), a butyl rubber (IIR), a hydrindantin rubber (ECO, CO), nylon, and the like. An additive such as particles may be added to the material of the intermediate layer 133 for imparting a specific surface roughness. The particles for imparting a specific surface roughness include silica, a urethane resin, a polyamide resin, a fluorine resin, an acryl resin, a silicone resin, and the like. The particles for imparting a specific surface roughness preferably have an average diameter in a range of 5 to 15 μm, and are added in a range of 10 to 40 weight % with respect to 100 weight % of the material of the intermediate layer 133.

In the embodiment, the surface layer 134 of the developing roller 13 may be formed of a material such as an acryl resin, an epoxy resin, a phenol resin, a polyester resin, a polyamide resin, a silicone resin, a urethane resin, and the like. The material may be modified, grafted, or polymerized to be a block copolymer, and may be used alone or a combination with other resins.

An additive such as a conductive agent, a charge control agent, and the like may be added to the material of the surface layer 134. The charge control agent may include quaternary ammonium salt, borate salt, an azine type (a nigrosine type) compound, an azo compound, an oxynaphthoic acid metal complex, a surfactant agent (an anion type, a cation type, or a nonionic type), and the like. Further, the material of the surface layer 134 may contain a stabilizing agent, an ultraviolet light absorbing agent, an anti-static agent, a reinforcing material, a flow promoter, a releasing agent, a pigment, a dye, a flame retardant agent, and the like.

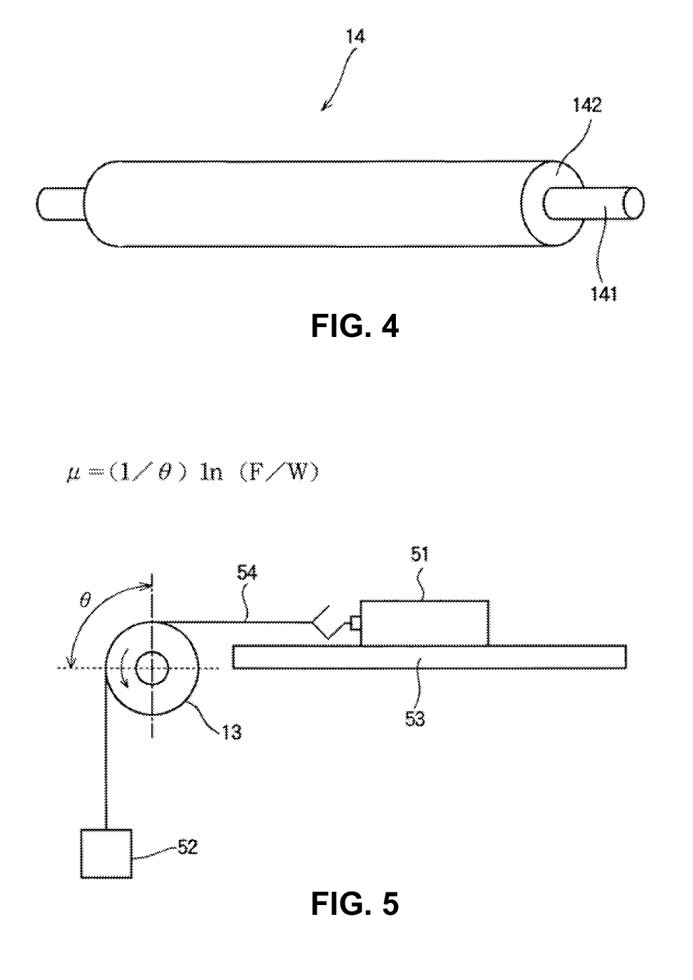

A configuration of the supplying roller 14 will be explained next. FIG. 4 is a schematic perspective view showing the supplying roller 14 of the developing device according to the first embodiment of the present invention.

In the embodiment, the supplying roller 14 is formed of a core metal 141 made of stainless steel (SUS) and an elastic foamed layer 142 disposed on an outer circumferential surface of the core metal 141. The supplying roller 14 has an outer diameter of 6 mm.

In the embodiment, the elastic foamed layer 142 of the supplying roller 14 is formed of a soft foamed member, which is foamed and cured after a polyol component, a polyisocyanate, a foaming agent (for example, pure water), and a catalyst are mixed and stirred.

In the embodiment, the polyol component may include a polyether polyol and a polyester polyol containing a polymer polyol. The polymer polyol is a compound having a polymerized chain and a plurality of hydroxyl groups at chain ends and the likes. More specifically, the polymer polyol is formed of a polyether polyol grafted with a compound having an ethylene unsaturated bonding such as a polyacrylonitrile, stylene, and a polymethacrylonitrile.

In the embodiment, the polyisocyanate may include various polyisocyanates of an aromatic type, an aliphatic type, and a cycloaliphatic type. The aromatic type polyisocyanate may include tolylene diisocyanate (TDI), 4,4′-diphenylmethane diisocyanate (MDI), 1,5-naphthalene diisocyanate, paraphenylene diisocyanate, and m-xylene diisocyanate. The aliphatic type polyisocyanate may include 1,6-hexamethylene diisocyanate (HDI), 2,2,4-trimethylene hexamethylene diisocyanate, 2,4,4-trimethylene hexamethylene diisocyanate, and the like. The cycloaliphatic type polyisocyanate may include isophorone diisocyanate, 4,4′-dicyclohexylmethane diisocyanate, hydrogenated MDI, and the like. The polyisocyanate may be used alone or mixed with other type of polyisocyanate. The aromatic type polyisocyanate, the aliphatic type polyisocyanate, and the cycloaliphatic type polyisocyanate may be mixed or modified.

In the embodiment, the foaming agent is mainly formed of pure water, and may include methylene chloride, pentane, cyclopentane, hexane, cyclohexane, chloromethane, a chlorofluorocarbon type compound, carbon dioxide, and the like. The catalyst may also contain an amine type catalyst (in particular, a tertiary amine such as triethylene diamine, dimethylethanol amine, N,N′,N′-trimethyl aminoethyl piperazine, and the like), and an organic metal compound such as octylic acid stannum (stannum octate).

In the embodiment, a foaming control agent may be used. The foaming control agent may include an organosiloxane-polyoxyalkylene copolymer, a non-ion type surfactant agent formed of a silicone compound such as a silicone-grease copolymer, a mixture thereof, an anion type surfactant agent such as dodecylbenzenesulfonic acid and potassium lauryl sulfate, a phenol type compound, and the like.

In the embodiment, the elastic foamed layer 142 may contain a conductive agent for imparting conductivity through an electron conductivity mechanism. The conductive agent includes carbon black such as furnace black, thermal black, channel black, acethylene black, ketjen black, color black, and the like; powders such as graphite; a fibrous substance; metal powders or fibrous substance of copper, nickel, silver, and the like; a metal oxide such as tin oxide, titanium oxide, indium oxide, and the like; and organic type conductive powders made of polyacetylene, polypyrrole, polyaniline, and the like.

In the embodiment, the toner is a negatively charged crashed type formed of a non-magnetic one-component, and has an average volume particle size of 5.5 μm. The toner may have a saturated electric charge amount of −44 μC/g. The saturated electric charge may be measured using a charge amount measurement device Q/M Meter Model 210HS (a product of Trek Incorporated) after 4 wt % of the toner and 96 wt % of a silicone coated ferrite (a product of KANTO CHEMICAL CO., INC., an average particle diameter of 90 μm) are mixed for one minute in a ball mill.

In the embodiment, the regulating blade 16 is formed of a plate shape member made of a material such as stainless steel (SUS), and has a thickness of 0.08 mm. Further, the regulating blade 16 has a contact portion abutting against the developing roller 13 in a curved shape. The curved shape has a curvature radius of, for example, 0.5 mm, and a surface roughness of 0.6 μm measured with a ten-point average surface roughness measurement method.

An experiment for evaluating the developing roller 13 will be explained next. In the experiment for evaluating the developing roller 13, five developing rollers A, B, C, D, and E were produced using different materials. A method of producing the five developing rollers A, B, C, D, and E will be explained next.

In producing the developing roller A, first, the elastic layer 132 made of a silicone rubber was formed on the outer circumferential surface of the core metal 131 having an outer diameter of 10 mm, thereby producing a base roll. In the next step, a conductive composition of the surface layer 134 was prepared. The conductive composition included 20 weight parts of a silicone modified acrylic resin; 60 weight parts of a melamine resin (SUPER BECKAMINE P-138, a product of DIC Corporation); 20 weight parts of an isocyanate compound (Colonate L, a product of Nippon Polyurethane Industry Co., Ltd.); 10 weight parts of a conductive carbon black as the conductive agent (Diablack #3030, a product of Mitsubishi Chemical Corporation); and 30 weight parts of acryl resin particles as a surface roughness control agent (Epostar MA1010, an average particle diameter of 10 μm, a product of NIPPON SHOKUBAI CO., LTD.). The conductive composition was dissolved in methylethylketone to prepare a coating solution having a concentration of 20 wt %. In the next step, after the coating solution was coated on the outer circumferential surface of the base roll, the coating solution was heated and vulcanized in an oven at 200° C. for 30 minutes, thereby producing the developing roller A. In the developing roller A, the surface layer 134 had a thickness of 10 μm and a surface roughness Ra of 1.06 μm. It is noted that the intermediate layer 133 shown in FIG. 3 was not provided in the developing roller A.

In producing the developing roller B, similar to the developing roller A, the elastic layer 132 made of a silicone rubber was formed on the outer circumferential surface of the core metal 131 having an outer diameter of 10 mm, thereby producing the base roll. In the next step, a conductive composition of the surface layer 134 was prepared. The conductive composition included 100 weight parts of an acrylic resin (THERMOLAC SU28, a product of Soken Chemical & Engineering Co., Ltd.); 25 weight parts of a conductive carbon black as the conductive agent (Diablack #3030, a product of Mitsubishi Chemical Corporation); 10 weight parts of an isocyanate compound (Colonate C-HX, a product of Nippon Polyurethane Industry Co., Ltd.); and 30 weight parts of acryl resin particles as the surface roughness control agent (Epostar MA1010, an average particle diameter of 10 μm, a product of NIPPON SHOKUBAI CO., LTD.). The conductive composition was dissolved in methylethylketone to prepare a coating solution having a concentration of 20 wt %. In the next step, after the coating solution was coated on the outer circumferential surface of the base roll, the coating solution was heated and vulcanized in an oven at 150° C. for 30 minutes, thereby producing the developing roller B. In the developing roller B, the surface layer 134 had a thickness of 10 μm and a surface roughness Ra of 1.13 μm.

In producing the developing roller C, similar to the developing roller A, the elastic layer 132 made of a silicone rubber was formed on the outer circumferential surface of the core metal 131 having an outer diameter of 10 mm, thereby producing the base roll. In the next step, a conductive composition of the surface layer 134 was prepared. The conductive composition included 100 weight parts of a polyester polyol as a raw material of a urethane resin; 30 weight parts of an isocyanate compound as another raw material of the urethane resin (Colonate C-HX, a product of Nippon Polyurethane Industry Co., Ltd.); 10 weight parts of a silicone grafted acryl resin (a number average molecular weight of 5,000); 30 weight parts of a conductive carbon black as the conductive agent (Diablack #3030, a product of Mitsubishi Chemical Corporation); and 30 weight parts of acryl resin particles as the surface roughness control agent (Epostar MA1010, an average particle diameter of 10 μm, a product of NIPPON SHOKUBAI CO., LTD.). The conductive composition was dissolved in methylethylketone to prepare a coating solution having a concentration of 20 wt %. In the next step, after the coating solution was coated on the outer circumferential surface of the base roll, the coating solution was heated and vulcanized in an oven at 170° C. for 60 minutes, thereby producing the developing roller C. In the developing roller C, the surface layer 134 had a thickness of 10 μm and a surface roughness Ra of 1.03 μm.

In producing the developing roller D, similar to the developing roller A, the elastic layer 132 made of a silicone rubber was formed on the outer circumferential surface of the core metal 131 having an outer diameter of 10 mm, thereby producing the base roll. In the next step, a conductive composition of the surface layer 134 was prepared. The conductive composition included 100 weight parts of NBR (Nipol DN101, a product of ZEON CORPORATION); 35 weight parts of a conductive carbon black as the conductive agent (Diablack #3030, a product of Mitsubishi Chemical Corporation); 5 weight parts of zinc oxide as a vulcanization support agent; 0.5 weight parts of sulfur as a vulcanization agent; 1 weight parts of a thiuram type vulcanization promoter (Accele TBT, a product of Kawaguchi Chemical Industry Co., LTD.); and 30 weight parts of acryl resin particles as the surface roughness control agent (Epostar MA1010, an average particle diameter of 10 μm, a product of NIPPON SHOKUBAI CO., LTD.). The conductive composition was dissolved in methylethylketone to prepare a coating solution having a concentration of 20 wt %. In the next step, after the coating solution was coated on the outer circumferential surface of the base roll, the coating solution was heated and vulcanized in an oven at 150° C. for 30 minutes, thereby producing the developing roller D. In the developing roller D, the surface layer 134 had a thickness of 10 μm and a surface roughness Ra of 1.03 μm.

In producing the developing roller E, the elastic layer 132 made of a conductive polyurethane was formed on the outer circumferential surface of the core metal 131 having an outer diameter of 10 mm, thereby producing the base roll. In forming the elastic layer 132, 0.005 weight parts of lithium perchlorate was added to 100 weight parts of a polyester polyol (Kurapol P-2010, a product of KURARAY Co., Ltd.). After the mixture was stirred and dissolved, the mixture was maintained at 100° C., and 16 weight parts of an isocyanate compound (Colonate C-HX, a product of Nippon Polyurethane Industry Co., Ltd.) was added and stirred, thereby preparing a mixture. The mixture was poured in a die metal preheated at 120° C., in which the core metal 131 (an outer diameter of 10 mm) was placed in advance. Then, the mixture was heated at 120° C. for 60 minutes. The core metal 131 was removed from the die metal, and a surface was polished to obtain a specific outer diameter, thereby preparing a base roll of the conductive polyurethane.

In the next step in producing the developing roller E, a surface treatment solution was prepared as follows. 100 weight parts of polymethylene plyphenyl isocyanate (MR400, a product of Nippon Polyurethane Industry Co., Ltd.) was added to and mixed with 100 weight parts of an alcohol modified silicone oil (SF8427, a product of Dow Corning Toray Co., Ltd.). After the mixture was reacted at 120° C. for 15 minutes, the mixture was dissolved in 2,000 weight parts of ethyl acetate, thereby preparing the surface treatment solution. The base roll was immersed in the surface treatment solution maintained at 100° C., thereby producing the developing roller E. The developing roller E had a surface roughness Ra of 1.15 μm.

In the experiment, a supplying roller a was produced as the supplying roller 14. A method of producing the supplying roller a will be explained next.

In producing the supplying roller a, first, a polyol component, a polyisocyanate, pure water, a catalyst, and a foaming control agent were mixed at a composition shown in Table 1, thereby preparing a mixture.

TABLE 1

| | | Supplying roller a |
|---|---|---|
| Composition | Polyol 1 | 50 |
| (weight parts) | Polyol 2 | 50 |
| | Polyisocyanate | 110 |
| | Pure water (foaming | 2 |
| | agent) | |
| | Catalyst 1 | 0 |
| | Catalyst 2 | 0 |
| | Foaming control | 1 |
| | agent | |

In Table 1, the polyol 1 was a polyether polyol (GP-3050, a product of Sanyo Chemical Industries, Ltd.). The polyol 2 was an acrylonitrile-stylene graft polymer polyol (Excenol 941, a product of Asahi Glass Co., Ltd.). The polyisocyanate was tolylene diisocyanate (TDI-80, a mixture of 80% of 2,4-tolylene diisocyanate and 20% of 2,6-tolylene diisocyanate, a product of Mitsui Takeda Chemicals, Inc.). The catalyst 1 was an amine catalyst (Kaolyzer No. 31, a product of Kao Corporation). The catalyst 2 was an amine catalyst (Kaolyzer No. 22, a product of Kao Corporation). The foaming control agent was a silicone type surfactant agent (B8110, a product of Goldschmidt Co., Ltd.). In the next step of producing the supplying roller a, the mixture was poured in a square container having a side length of 500 mm, and the mixture was foamed at a room temperature under atmospheric pressure. Then, the square container was passed through a heating oven to heat the mixture, so that the mixture was reacted and cured, thereby obtaining a soft foamed member.

In the next step of producing the supplying roller a, the soft foamed member was cut into a rectangular member having a side of 400 mm and a height of 25 mm, and then the rectangular member was immersed in a conductive processing solution at 20° C. for five minutes. The conductive processing solution was prepared by adding and stirring 30 wt % of a carbon black dispersion solution (Ecomal black, a solid content of 36%, a product of SANYO COLOR WORKS, Ltd.) in an acrylic resin emulsion (Nipol 1851, a solid contact of 45%, a product of ZEON CORPORATION).

In the next step in producing the supplying roller a, after the rectangular member was immersed in the conductive processing solution, the rectangular member was passes through a pair of tool rolls arranged with an interval of 0.2 mm, thereby squeezing out an excess amount of the conductive processing solution. Afterward, the rectangular member was heated and dried in a hot air circulation oven at 100° C. for 60 minutes. Through the heating and drying process, moisture was removed from the rectangular member of the foamed member, and the acrylic resin was cross-linked, so that carbon black was strongly adhered to walls of the continuous foam cells, thereby producing a conductive foamed member to be used for the elastic foamed layer 142.

In the next step in producing the supplying roller a, the rectangular member was cut into a rectangular column member having a length of 300 mm and a square side surface with one side of 25 mm. Then, a through hole with a diameter of 5 mm was formed at a center of the rectangular column member, so that the core metal 141 could be inserted into the through hole. An adhesive was coated on a surface of the core metal 141 formed of stainless steel (an outer diameter of 6 mm). Then, the core metal 141 passed through and adhered to the through hole. In the final step, the rectangular column member of the conductive foamed member was polished in a cylindrical shape to have an outer diameter of 15.5 mm, thereby producing the supplying roller a. The supplying roller a had a rubber hardness of 31° according to an Asker F hardness.

A method of measuring a physical property of a component will be explained next. First, a method of measuring a static friction coefficient of the developing roller 13 will be explained. FIG. 5 is a schematic perspective view showing the method of measuring the static friction coefficient of the developing roller 13 of the developing device according to the first embodiment of the present invention.

In the method, the static friction coefficient of the developing roller 13 was measured according to the Euler's belt method. As shown in FIG. 5, the developing roller 13 was arranged to contact with an outer circumferential surface of a belt 54 at a specific contact angle θ. One end portion of the belt 54 was connected to a weight scale 51 fixed to a stage 55, and the other end portion of the belt 54 was connected to a weight portion 52.

In the method, a digital force gauge ZP-50N (a product of IMADA CO., LTD.) was used as the weight scale 51. The belt 54 had a width of 30 mm and a thickness of 30 μm, and was made of stainless steel. The developing roller 13 was arranged to rotate at a rotational speed of 100 rpm, and the weight portion 52 had a weight of 52 g.

In the method, when the developing roller 13 rotates in a specific direction (an arrow direction in FIG. 5, the static friction coefficient of the developing roller 13 is defined with the following equation:

μ=1/θ×1i(F/W)

where μ is the static friction coefficient; F is a measurement value of the weight scale 51; and W is the weight of the weight portion 52.

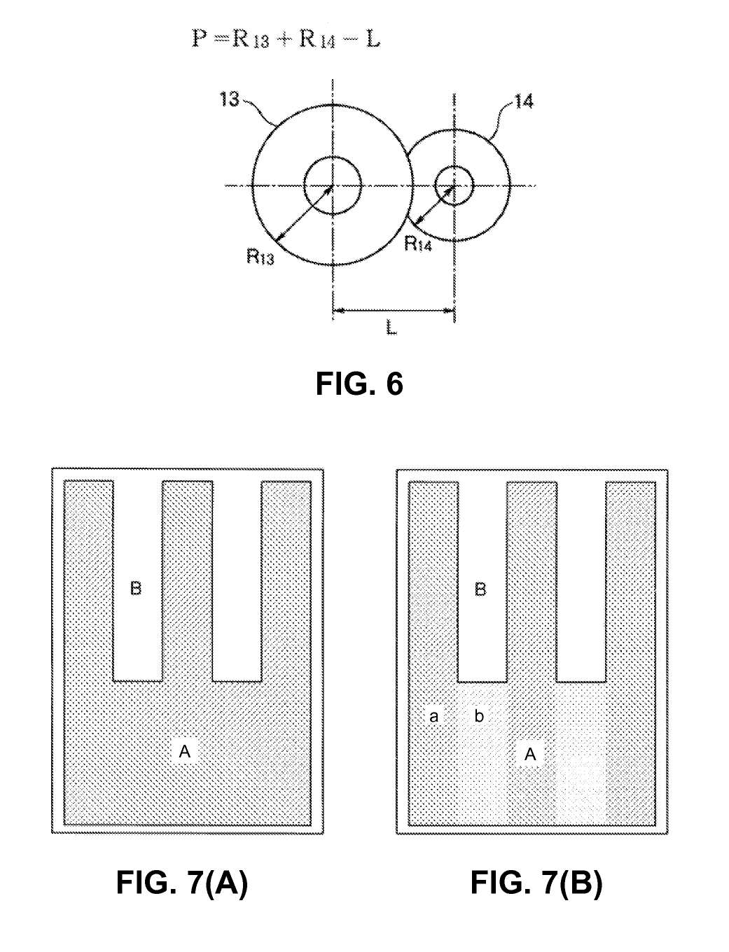

A method of measuring a pushing amount of the supply roller 14 will be explained next. FIG. 6 is a schematic perspective view showing the method of measuring the pushing amount of the supply roller 14 with respect to the developing roller 13 of the developing device according to the first embodiment of the present invention.

In the embodiment, the supplying roller 14 is arranged to push against the developing roller 13, so that the supplying roller 14 removes remaining toner (toner not attached to the photosensitive drum 11) on the surface of the developing roller 13. Accordingly, a capability of the supplying roller 14 for removing remaining toner on the surface of the developing roller 13 depends on the pushing amount of the supplying roller 14 with respect to the developing roller 13.

As shown in FIG. 6, when the developing roller 13 is arranged away from the supplying roller 14 by an inter-axial distance L, the pushing amount of the supplying roller 14 with respect to the developing roller 13 is defined with the following equation:

P=R₁₃+R₁₄−L

where P is the pushing amount of the supplying roller 14 with respect to the developing roller 13; R₁₃ is a radius of the developing roller 13; and R₁₄ is a radius of the supplying roller 14.

Alternatively, the pushing amount of the supplying roller 14 with respect to the developing roller 13 is defined with the following equation:

P=(D₁₃+D₁₄)/2−L

where D₁₃ is a diameter of the developing roller 13 and D₁₄ is a diameter of the supplying roller 14.

In the experiment, the pushing amount of the supplying roller 14 with respect to the developing roller 13 was changed through varying the inter-axial distance L between the developing roller 13 and the supplying roller 14. It is noted that an axis supporting portion of the supplying roller 14 (a bearing metal) is configured such that the supplying roller 14 is movable in an approaching direction or a departing direction with respect to the developing roller 13 for adjusting the inter-axial distance L between the developing roller 13 and the supplying roller 14. Accordingly, it is possible to accurately adjust the inter-axial distance L between the developing roller 13 and the supplying roller 14 with a micro-gauge and the like.

In the experiment for evaluating the developing rollers A to E, a printing test was conducted using an optical LED type color electro-photography printer MICROLINE 5900dn (a product of OKI DATA CORPORATION; a resolution of 600 DPI). Toner formed of a non-magnetic one component with a negatively charging crash manufacturing method was used as developer, and had a volume average particle size of 5.5 μm. Further, the printing test was conducted under an environment with a room temperature of 23° C. and relative humidity of 45% RH.

In the printing test described above, the color electro-photography printer printed a test pattern shown in FIG. 7(A). FIGS. 7(A) and 7(B) are schematic views for explaining a method of evaluating ghost of the developing device according to the first embodiment of the present invention. As shown in FIG. 7(A), the test pattern had a solid portion A with a density of 100% and a white portion B with a density of 0%. It is noted that, in FIGS. 7(A) and 7(B), the solid portion A is represented with a hatching pattern.

In the printing test, after the color electro-photography printer printed the test pattern, a density was measured with a spectrum density meter X-Rite 528 (the product of X-Rite Incorporated) at a location a and a location b in the solid portion A. At the location b, the solid portion A was printed right after the white portion B was printed. When remaining toner on the surface of the developing roller 13 was not sufficiently removed, as shown in FIG. 7(B), a cloudy portion appeared at the location b where the solid portion A was printed right after the white portion B was printed. When a difference between the density at the location a and the density at the location b was less than 0.05, the result was represented as good. When the difference was around 0.05, the result was represented as fair. When the difference was greater than 0.05, the result was represented as poor.

In the experiment, the test pattern shown in FIG. 7(A) was printed for evaluating Sample No. 1-1 to Sample No. 1-3 and Comparative Sample No. 1-1 to Comparative Sample No. 1-2. Further, the static friction coefficients of the developing rollers A to E were measured with the method shown in FIG. 5. Results of the evaluation and the measurement are shown in Table 2.

TABLE 2

| | | Static | | | | | | |
|---|---|---|---|---|---|---|---|---|
| | Developing | friction | Pushing amount of supply roller a | | | | | |
| | roller | coefficient μ | 0.3 | 0.5 | 0.7 | 1.0 | 1.5 | 2.0 |
| Sample No. 1-1 | A | 0.41 | Fair | Good | Good | Good | Good | Fair |
| Sample No. 1-2 | B | 0.72 | Poor | Good | Good | Good | Good | Fair |
| Sample No. 1-3 | C | 1.81 | Poor | Good | Good | Good | Good | Fair |
| Comparative | D | 3.20 | Poor | Poor | Poor | Poor | Fair | Fair |
| Sample No. 1-1 | | | | | | | | |
| Comparative | E | 4.72 | Poor | Poor | Poor | Poor | Poor | Poor |
| Sample No. 1-2 | | | | | | | | |

In Sample No. 1-1, the developing roller A and the supply roller a were arranged such that the pushing amount of the supply roller a with respect to the developing roller A was varied in a range from 0.3 mm to 2.0 mm, and the test pattern was printed. The developing roller A had the static friction coefficient of 0.41, a very small level. In the evaluation of the printing test, when the pushing amount of the supply roller a with respect to the developing roller A was in a range from 0.5 mm to 1.5 mm, it was possible to obtain the good results in the printing test (the difference in the densities was less than 0.05).

Accordingly, when the pushing amount was in the range of 0.5 mm and 1.5 mm, it was possible to properly scrape off remaining toner on the surface of the developing roller 13, thereby preventing ghost. On the other hand, when the pushing amount was set to 0.3 mm, the result was fair (the difference in the densities was 0.05). When the pushing amount was set to 2.0 mm, a torque (load) of a motor of the developing device increased.

In Sample No. 1-2, the developing roller B and the supply roller a were arranged similar to Sample No. 1-1, and the test pattern was printed. The developing roller B had the static friction coefficient of 0.72, a small level. In the evaluation of the printing test, when the pushing amount of the supply roller a with respect to the developing roller B was in a range from 0.5 mm to 1.5 mm, it was possible to obtain the good results in the printing test (the difference in the densities was less than 0.05). On the other hand, when the pushing amount was set to 2.0 mm, the torque (load) of the motor of the developing device increased.

In Sample No. 1-3, the developing roller C and the supply roller a were arranged similar to Sample No. 1-1, and the test pattern was printed. The developing roller C had the static friction coefficient of 1.81, a small level. In the evaluation of the printing test, when the pushing amount of the supply roller a with respect to the developing roller C was in a range from 0.5 mm to 1.5 mm, it was possible to obtain the good results in the printing test (the difference in the densities was less than 0.05). On the other hand, when the pushing amount was set to 2.0 mm, the torque (load) of the motor of the developing device increased.

In Comparative Sample No. 1-1, the developing roller D and the supply roller a were arranged similar to Sample No. 1-1, and the test pattern was printed. The developing roller D had the static friction coefficient of 3.20, a relatively large level. In the evaluation of the printing test, when the pushing amount of the supply roller a with respect to the developing roller D was in a range from 0.3 mm to 1.0 mm, it was not possible to obtain the good results in the printing test. When the pushing amount was set in a range of 1.5 mm and 2.0 mm, the torque (load) of the motor of the developing device increased.

In Comparative Sample No. 1-2, the developing roller E and the supply roller a were arranged similar to Sample No. 1-1, and the test pattern was printed. The developing roller E had the static friction coefficient of 7.72, an extremely large level. In the evaluation of the printing test, when the pushing amount of the supply roller a with respect to the developing roller E was set to any level, it was not possible to obtain the good results in the printing test. Accordingly, it was not possible to properly scrape off remaining toner on the surface of the developing roller 13 and prevent ghost.

As described above, when the developing roller 13 has the static friction coefficient in the range of 0.41 and 1.81, and the pushing amount of the supply roller 14 with respect to the developing roller 13 is in the range from 0.5 mm to 1.5 mm, it is possible to prevent ghost and obtain an image with good quality without increasing the torque of the motor.

In the embodiment, as described above, the supplying roller 14 includes the elastic foamed layer 142 (the conductive foamed member), in which carbon black is attached to foam cell walls of the foamed member (the soft foamed member) formed through the foaming process. Accordingly, it is possible to effectively scrape off remaining toner on the surface of the developing roller 13, thereby effectively preventing ghost.

Further, in the embodiment, as described above, the developing roller 13 includes the surface layer 134 formed of a material containing at least one of an acryl resin, an epoxy resin, a phenol resin, a polyester resin, a polyamide resin, a silicone resin, and a urethane resin. Accordingly, it is possible to reduce the static friction coefficient of the developing roller 13, thereby effectively preventing ghost and reducing the torque of the motor of the developing device.

### Second Embodiment

A second embodiment of the present invention will be explained next. In the first embodiment described above, the developing roller 13 has the static friction coefficient in the range of 0.41 and 1.81, and the pushing amount of the supply roller 14 with respect to the developing roller 13 is set in the range from 0.5 mm to 1.5 mm. Accordingly, it is possible to prevent ghost. When the supplying roller 14 is pressed against the developing roller 13 for a prolonged period of time, however, the outer circumferential surface of the supplying roller 14 may have a dent. In this case, it is difficult to generate a stable supply electric field between the supplying roller 14 and the developing roller 13, thereby causing an image irregularity with a pitch associated with the dent of the supplying roller 14.

To this end, in the second embodiment, it is possible to improve a residual strain in the supplying roller 14 when the supplying roller 14 is remained to press against the developing roller 13 for a prolonged period of time.

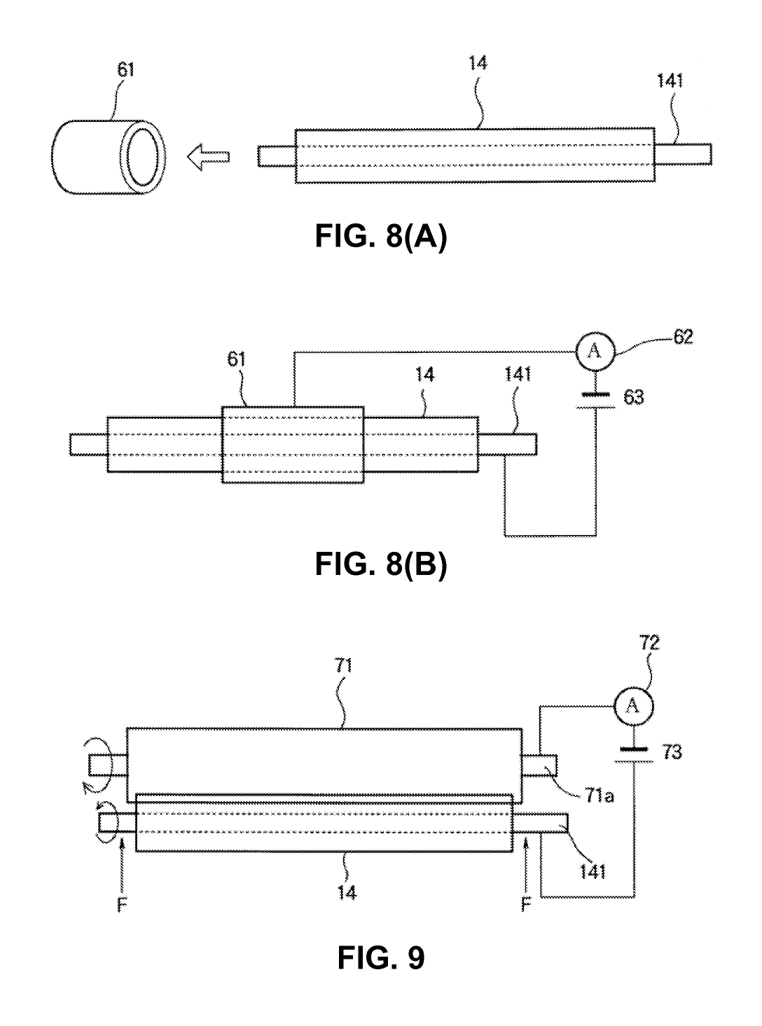

A method of measuring a physical property of a component will be explained. First, a method of measuring an electric resistivity of the foamed member of the supply roller 14 of the developing device will be explained. FIGS. 8(A) and 8(B) are schematic views showing the method of measuring the electric resistivity (volume resistivity) of the foamed member of the supply roller 14 of the developing device before carbon black is fixed to the foamed member according to the second embodiment of the present invention.

In the measurement, the core metal 141 had an outer diameter of 6.0 mm. Further, the supplying roller 14 was processed to have an outer diameter (that is, an outer diameter of the elastic foamed layer 142) of 15.5 mm. Then, as shown in FIG. 8(A), a metal (stainless steel) pipe 61 with a cylindrical shape closely covered the circumferential surface of the supplying roller 14.

As shown in FIG. 8(B), when the electrical resistivity of the foamed member was measured, first, electrode terminals of a direct current power source 63 were connected to the core metal 141 and the metal pipe 61, respectively. Then, a voltage was applied between the core metal 141 and the metal pipe 61. An ultrahigh resistance meter 8340A (a product of ADC CORPORATION) was used to detect the applied voltage and measure a measurement value (a current value), so that the electrical resistivity was calculated from a length and an inner diameter of the metal pipe 61 and an inner diameter of the elastic foamed layer 142.

FIG. 9 is a schematic view showing the method of measuring the electric resistivity of the supply roller 14 of the developing device according to the second embodiment of the present invention.

As shown in FIG. 9, when the electric resistivity of the supply roller 14 was measured, a metal cylindrical tube 71 was arranged in parallel to the outer circumferential surface of the supplying roller 14, so that the metal cylindrical tube 71 abutted against the outer circumferential surface of the supplying roller 14. Then, the supplying roller 14 and the metal cylindrical tube 71 were rotated. Then, electrode terminals of a direct current power source 73 were connected to the core metal 141 and the metal cylindrical tube 71, respectively, and a voltage was applied between the core metal 141 and the metal cylindrical tube 71. Similar to the method shown in FIG. 8(B), the ultrahigh resistance meter 8340A (a product of ADC CORPORATION) was used to detect the applied voltage and measure a measurement value (a current value).

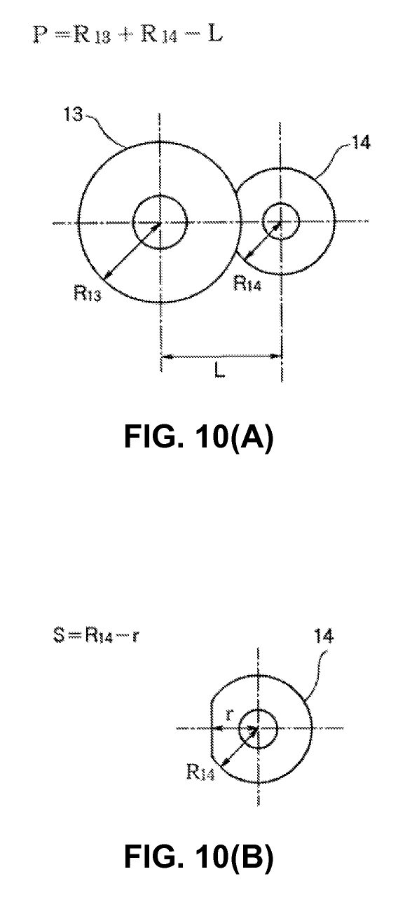

A method of measuring the residual strain of the supply roller 14 of the developing device will be explained next. FIGS. 10(A) and 10(B) are schematic views showing the method of measuring the residual strain of the supply roller 14 of the developing device according to the second embodiment of the present invention.

As shown in FIG. 10(A), the supplying roller 14 is arranged to push against (into) the developing roller 13. When the supplying roller 14 and the developing roller 13 stay in this state for a prolonged period of time under a high temperature and high humidity condition, the supplying roller 14 may have a dent at a location where the supplying roller 14 abuts against the developing roller 13. The dent is referred to as the residual strain S.

As shown in FIG. 10(B), the residual strain S is defined as a difference between an original radius R₁₄ of the supplying roller 14 (the radius before the prolonged storage period) and a radius r of an abutting portion (a distance between a center of the supplying roller 14 and the abutting portion). That is, the residual strain S is represented with the following equation:

S=R₁₄−r

In measuring the residual strain S, as shown in FIG. 10(A), the supplying roller 14 was arranged to abut against the developing roller 13 with a specific pushing amount (refer to Table 4 described later). After the supplying roller 14 and the developing roller 13 were maintained in this state for one month under a temperature of 50° C. and humidity of 55%, the developing roller 13 was removed from the supplying roller 14. After 24 hours, the radius r of the supplying roller 14 at the abutting portion was measured with a gauge and the like, so that the residual strain was calculated (S=R₁₄−r).

From a previous experiment, it was known that, when the residual strain S(S=R₁₄−r) was less than 0.15 mm, a density irregularity (an image irregularity with a pitch associated with the dent of the supplying roller 14) did not occur. Accordingly, the supplying roller 14 needs to have the residual strain S of less than 0.15 mm in measuring the residual strain S.

Further, from another previous experiment, when the supplying roller 14 had a foam cell diameter in a range of 100 μm and 600 μm, it was possible to generate a stable supply electric field between the supplying roller 14 and the developing roller 13. Further, it was possible to stably scrape off remaining toner on the surface of the developing roller 13, thereby obtaining an image with high quality. Accordingly, when the supplying roller 14 had the foam cell diameter in the range of 100 μm and 600 μm, the result was represented as good. When the supplying roller 14 had the foam cell diameter less than 100 μm or greater than 600 μm, the result was represented as poor. When the foam cell diameter was measured, first, an area of the surface of the supplying roller 14 was arbitrarily selected, and an optical microscope was used to measure sizes of foam cells on a strain line of 25 mm, thereby obtaining the foam cell diameter.

An experiment for evaluating the supplying roller 14 will be explained next. In the experiment for evaluating the supplying roller 14, four supplying rollers b to e were produced using different compositions. The supplying roller a explained in the first embodiment was used as a comparative example.

In the experiment, when the supplying rollers b to e were produced, different from the supplying roller a described above, the elastic foamed layer 142 of each of the supplying rollers b to e was formed using carbon black (ketjen black EC600JD, a product of Lion Corporation) at an amount of 0.1 weight part, 2.0 weight parts, 5 weight parts, and 8 weight parts, respectively (refer to Table 3).

Further, the foaming agent (pure water), the catalyst 1, and catalyst 2 had different compositions from those of the supplying roller a (refer to Table 3). Other conditions were similar to those of the supplying roller a. The supplying rollers b to e had an outer diameter of 15.5 mm, the same as that of the supplying roller a. The supplying rollers b to e had a rubber hardness of 31°, 32°, 34°, and 39°, respectively, according to the Asker F hardness

As described above, the electrical resistivity ρ (log Ω·cm) of the foamed member before the carbon black fixing process was measured with the method shown in FIGS. 8(A) and 8(B) at an applied voltage of 10 V, and results thereof are shown in Table 3. When the electric resistivity was too high and exceeded an electrical current reading range of the measurement device, the applied voltage was adjusted to a voltage shown in parenthesis in Table 3. Further, the electrical resistivity R (log Ω-cm) of the foamed member after the carbon black fixing process was measured with the method shown in FIG. 9, and results thereof are shown in Table 3.

TABLE 3

| | | Roller a | Roller b | Roller c | Roller d | Roller e |
|---|---|---|---|---|---|---|
| Composition | Polyol 1 | 50 | 50 | 50 | 50 | 50 |
| (weight parts) | Polyol 2 | 50 | 50 | 50 | 50 | 50 |
| | Polyisocyanate | 110 | 110 | 110 | 110 | 110 |
| | Pure water | 2 | 1.7 | 1.7 | 1.7 | 1.7 |
| | (foaming agent) | | | | | |
| | Catalyst 1 | 0 | 0.3 | 0.3 | 0.3 | 0.3 |
| | Catalyst 2 | 0 | 0.2 | 0.2 | 0.2 | 0.2 |
| | Foaming control | 1.0 | 1.0 | 1.0 | 1.0 | 1.0 |
| | agent | | | | | |
| | carbon black | 0 | 0.1 | 2.0 | 5.0 | 9.0 |

| | | | | | |
|---|---|---|---|---|---|
| Electrical resistivity ρ (log Ω · cm) | 12.3 | 12.1 | 11.4 | 9.1 | 8.9 |
| of foamed member at 10 V | (500 V) | (500 V) | | | |
| before carbon fixing process | | | | | |

| | | |
|---|---|---|
| Carbon black | Fixing agent | Acrylic type emulsion |
| fixing process | Conductive agent | Carbon aqueous dispersion |

| | | | | | |
|---|---|---|---|---|---|
| Electrical resistivity R (log Ω · cm) | 6.3 | 6.2 | 5.7 | 4.7 | 4.0 |
| of supplying roller at 10 μA | | | | | |
| after carbon fixing process | | | | | |
| Uniformity of foam cell diameter | Good | Good | Good | Good | Poor |

As described above, the residual strains of the supplying rollers a to d were measured with the method shown in FIGS. 10(A) and 10(B), and the density irregularity was evaluated. Results of the measurement and the evaluation are shown in Table 4.

TABLE 4

| | Supplying | Pushing | Residual | Density |
|---|---|---|---|---|
| | roller | amount | strain | irregularity |
| Sample No. | Roller b | 0.5 mm | 0.07 mm | Good |
| 2-1 | | | | |
| Sample No. | Roller b | 1.0 mm | 0.13 mm | Good |
| 2-2 | | | | |
| Sample No. | Roller b | 1.5 mm | 0.15 mm | Good |
| 2-3 | | | | |
| Sample No. | Roller c | 1.0 mm | 0.09 mm | Good |
| 2-4 | | | | |
| Sample No. | Roller d | 1.0 mm | 0.08 mm | Good |
| 2-5 | | | | |
| Comparative | Roller a | 1.0 mm | 0.36 mm | Poor |
| sample No. | | | | |
| 2-1 | | | | |

As shown in Table 4, in Sample No. 2-1, the supplying roller b was pushed against the developing roller 13 with the pushing amount of 0.5 mm. As a result, the residual strain was 0.07 mm, and it was possible to obtain a uniform image without density irregularity.

In Sample No. 2-2, the supplying roller b was pushed against the developing roller 13 with the pushing amount of 1.0 mm. As a result, the residual strain was 0.13 mm, and it was possible to obtain a uniform image without density irregularity.

In Sample No. 2-3, the supplying roller b was pushed against the developing roller 13 with the pushing amount of 1.5 mm. As a result, the residual strain was 0.15 mm, and it was possible to obtain a uniform image without density irregularity.

In Sample No. 2-4, the supplying roller c was pushed against the developing roller 13 with the pushing amount of 1.0 mm. As a result, the residual strain was 0.09 mm, and it was possible to obtain a uniform image without density irregularity.

In Sample No. 2-5, the supplying roller d was pushed against the developing roller 13 with the pushing amount of 1.0 mm. As a result, the residual strain was 0.08 mm, and it was possible to obtain a uniform image without density irregularity.

In Comparative Sample No. 2-1, the supplying roller a was pushed against the developing roller 13 with the pushing amount of 1.0 mm. As a result, the residual strain was 0.36 mm, and it was observed that density irregularity occurred with the pitch of the dent generated in the outer circumferential surface of the supplying roller a.

In the experiment, when the foam cell diameter of each of the supplying rollers b to e was measured, it was found that the supplying rollers b to d had the foam cell diameter within a range of 100 μm and 600 μm, resulting in uniform foam cells with a small variance. Further, it was found that the supplying roller e had the foam cell diameter with a large variance.

As described above, the supplying rollers b to d contained a small amount of carbon black. As a result, the supplying rollers b to d had the uniform foam cells with a small variance in foam cell diameter, thereby making it possible to contain a large amount of air therein. Further, a small amount of carbon black contained therein reinforced a molecular structure of a thin cell wall with flexibility. Accordingly, it was possible to obtain the foamed member with a sufficient rigidity against deformation (capable of restraining the residual strain less than 0.15 mm) while maintaining a low hardness and soft texture. As a result, it was possible to obtain an image with good quality without ghost or density irregularity.

In the experiment, it was noted that the supplying roller e contained carbon black of 8 weight parts. As a result, the supplying roller e exhibited the electrical resistivity ρ (log Ω·cm) of 8.9, and had the foam cell diameter with a large variance. When a large amount of carbon black was contained, it was thought to be difficult to stably form the foam cells. When the foam cell diameter had a large variance, it was difficult to generate a stable supply electric field between the supplying roller 14 and the developing roller 13, thereby making it difficult to obtain an image with good quality.

As described above, it is preferred that the foam member contains carbon black in a specific amount, so that the foam member has the electrical resistivity ρ (log Ω·cm) in a range of 9.1 and 12.1. Then, the carbon fixing process is performed on the foamed member, in which carbon black is attached to the foam cell walls, thereby producing the elastic foamed layer 142. Finally, the supplying roller 14 is produced using the elastic foamed layer 142, and is arranged to push against the developing roller 13 with the pushing amount of 0.5 mm to 1.5 mm. As a result, it is possible to reduce the residual strain and the density irregularity, thereby preventing ghost.

It is noted that the preferable range of 9.1 and 12.1 of the electrical resistivity ρ (log Ω·cm) can be converted to a range of 1.16×10⁹ and 1.26×10¹² (Ω·cm) in the logarithmic expression.

Samples No. 2-1 to 2-4 are typical examples, and the invention is not limited thereto. It is sufficient that the foam member contains carbon black in a specific amount, so that the foam member has the electrical resistivity in the range of 1.16×10⁹ and 1.26×10¹² (Ω·cm). Then, the carbon fixing process is performed on the foamed member, in which carbon black is attached to the foam cell walls, thereby producing the elastic foamed layer 142. Finally, the supplying roller 14 is produced using the elastic foamed layer 142, and is arranged to push against the developing roller 13 with the pushing amount of 0.5 mm to 1.5 mm. As a result, it is possible to reduce the residual strain and the density irregularity, thereby preventing ghost.

As described above, in the second embodiment, the foam member contains carbon black in a specific amount, so that the foam member has the electrical resistivity in the range of 1.16×10⁹ and 1.26×10¹² (Ω·cm). Then, the carbon fixing process is performed on the foamed member, in which carbon black is attached to the foam cell walls, thereby producing the elastic foamed layer 142 of the supplying roller 14. As a result, it is possible to reduce the residual strain and the density irregularity, thereby preventing ghost.

In the first and second embodiments described above, the color printer of the electro-photography type is explained as the image forming apparatus, and the present invention may be applicable to a copier, a facsimile, and a MFP (Multi Function Product).

The disclosure of Japanese Patent Application No. 2009-210602, filed on Sep. 11, 2009, is incorporated in the application.

While the invention has been explained with reference to the specific embodiments of the invention, the explanation is illustrative and the invention is limited only by the appended claims.

What is claimed is:

1. A developing device comprising:
a developer supporting member for attaching developer to a static latent image supporting member supporting a static latent image; and
a developer supplying member for supplying developer to the developer supporting member, said developer supporting member having a surface with a static friction coefficient in a range of 0.41 and 1.81, said developer supplying member being arranged to push against the developer supporting member for a pushing amount in a range of 0.5 mm and 1.5 mm.

2. The developing device according to claim 1, wherein said developer supplying member includes an elastic foamed layer containing carbon black attached to foam cell walls of a foamed member formed through a foaming process.

3. The developing device according to claim 1, wherein said developer supplying member includes a foamed member containing carbon black and an electrical resistivity in a range of 1.16×10⁹ and 1.26×10¹² (Ω·cm), and an elastic foamed layer containing carbon black attached to foam cell walls of the foamed member.

4. The developing device according to claim 1, wherein said elastic foamed layer contains at least a polyol component, an isocyanate, and a foaming agent.

5. The developing device according to claim 2, wherein said elastic foamed layer contains at least a polyol component, an isocyanate, and a foaming agent.

6. The developing device according to claim 1, wherein said developer supporting member includes a surface layer formed containing at least one of an acrylic resin, an epoxy resin, a phenol resin, a polyester resin, a polyamide resin, a silicone resin, and a urethane resin.

7. An image forming apparatus comprising the developing device according to claim 1.
